(19) United States
(12) Patent Application Publication
(10) Pub. No.: US 2012/0198386 A1
(43) Pub. Date: Aug. 2, 2012

(54) CAUSING DISPLAY OF THUMBNAIL IMAGES

(75) Inventor: Ismo Hautala, (US)

(73) Assignee: Nokia Corporation

(21) Appl. No.: 13/017,711

(22) Filed: Jan. 31, 2011

(51) Int. Cl. G06F 15/00; G06F 3/048

(52) U.S. Cl. 715/838; 345/418

(57) ABSTRACT

Apparatus is configured to cause to be displayed a real-time image that represents image data output from an image sensing device and to cause to be displayed, over a portion of the displayed real-time image, at least one thumbnail image.

### FIELD

This specification relates generally to causing the display of thumbnail images.

### BACKGROUND

It is now common for portable devices, such as mobile phones, to have an integrated camera as well as a memory for storing images and videos captured by the camera. The captured images and videos are usually viewable by a user through a gallery application, which is accessible on the device through a menu or through an icon on a home screen. It is also now common for digital cameras (i.e. devices not including cellular telephone communication capabilities) to have a display that serves to display a viewfinder view for the camera and to display stored images in a playback mode. Modern digital cameras often have large memories or memory expansion options for storing large numbers of captured images and videos.

### SUMMARY

A first aspect of this specification provides apparatus configured:
to cause to be displayed a real-time image that represents image data output from an image sensing device; and
to cause to be displayed, over a portion of the displayed real-time image, at least one thumbnail image.

The apparatus may be further configured to be responsive to an image capture command to capture a first image and to cause to be displayed, over a portion of the displayed real-time image, a first thumbnail image representing the first captured image. The first thumbnail image representing the first captured image may be displayed immediately on capture.

The apparatus may be further configured to be responsive to a second image capture command to capture a second image and to cause to be displayed, over a portion of the displayed real-time image and adjacent the first thumbnail image, a second thumbnail image representing the second captured image. The second thumbnail image representing the second captured image may be displayed immediately on capture.

The apparatus may be further configured to cause the or each thumbnail image to be displayed at or near an edge of a display area. Here, the apparatus may be further configured to be responsive to a first user input to cause a greater number of thumbnail images to be displayed at or near the edge of the display area. This apparatus may be further configured to be responsive to a second user input to cause fewer thumbnail images to be displayed at or near the edge of the display area.

The apparatus may be further configured to be responsive to a third user input to cause one of the at least one thumbnail images to be enlarged to fill substantially the whole of the display. Here, the apparatus may be responsive to a fourth user input to cause the enlarged image to return to being a thumbnail image.

The apparatus may be responsive to a first user input to cause one of the at least one thumbnail images to be enlarged to fill substantially the whole of the displayed real-time image. The apparatus may be responsive to a second user input to cause one or more enlarged thumbnail images to be reduced in size so as to cover a smaller portion of the displayed real-time image. Each user input may be a touch input received at a touch sensitive screen. The apparatus may comprise a software application configured to cause both the real-time image and the at least one thumbnail image to be displayed.

A second aspect of the specification comprises a method comprising:
causing to be displayed a real-time image that represents image data output from an image sensing device; and
causing to be displayed, over a portion of the displayed real-time image, at least one thumbnail image.

A third aspect of the specification comprises a computer program comprising instructions that when executed by computer apparatus control it to perform this method.

A fourth aspect of the specification comprises apparatus comprising:
means for causing to be displayed a real-time image that represents image data output from an image sensing device; and
   means for causing to be displayed, over a portion of the displayed real-time image, at least one thumbnail image.

A fifth aspect of the specification comprises a non-transitory computer-readable storage medium having stored thereon computer-readable code, which, when executed by computing apparatus, causes the computing apparatus to perform a method comprising:
causing to be displayed a real-time image that represents image data output from an image sensing device; and
causing to be displayed, over a portion of the displayed real-time image, at least one thumbnail image.

A sixth aspect of the specification comprises apparatus, the apparatus having at least one processor and at least one memory having computer-readable code stored thereon which when executed controls the at least one processor:
to cause to be displayed a real-time image that represents image data output from an image sensing device; and
to cause to be displayed, over a portion of the displayed real-time image, at least one thumbnail image.

### BRIEF DESCRIPTION OF THE DRAWINGS

Embodiments will now be described, by way of example only, with reference to the accompanying drawings, in which:

FIG. 1 is a perspective view of a terminal according to embodiments;

FIG. 2 is a schematic diagram illustrating components of the FIG. 1 terminal and their interconnection;

FIGS. 3, 4, 5, 6 and 7 are screenshots from the terminal of FIGS. 1 and 2 showing various display configurations according to embodiments;

FIG. 8 is a flow chart depicting exemplary operation of the mobile terminal of FIGS. 1 and 2.

### DETAILED DESCRIPTION OF PREFERRED EMBODIMENTS

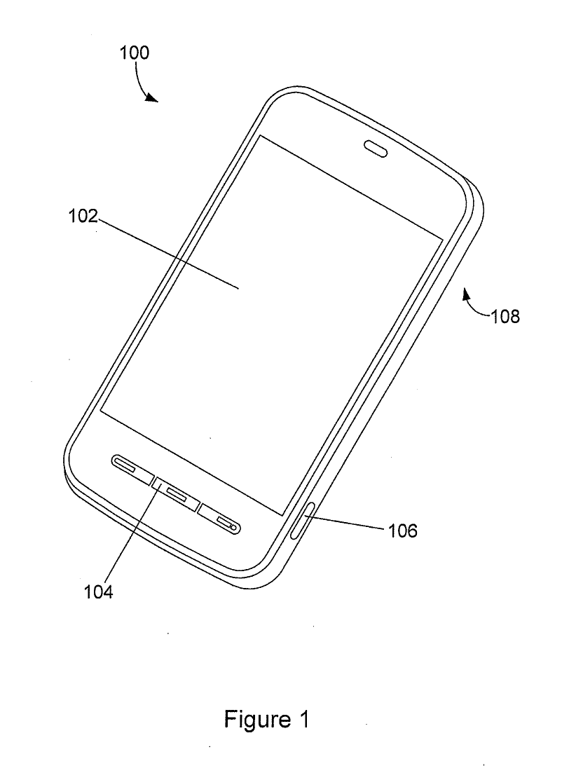

Referring firstly to FIG. 1, a terminal 100 is shown. The terminal 100 embodies various aspects and is not limiting on the scope of the claims. The terminal 100 has a touch sensitive display, or touchscreen, 102 for displaying content and for receiving tactile user inputs. The terminal also comprises one or more hardware keys 104, an image capture key 106 and a camera lens 108. The camera lens 108 is located on the back of the terminal 100 (the side opposite the display) and is not shown in FIG. 1. The terminal 100 may be a mobile phone, PDA, digital camera or other device.

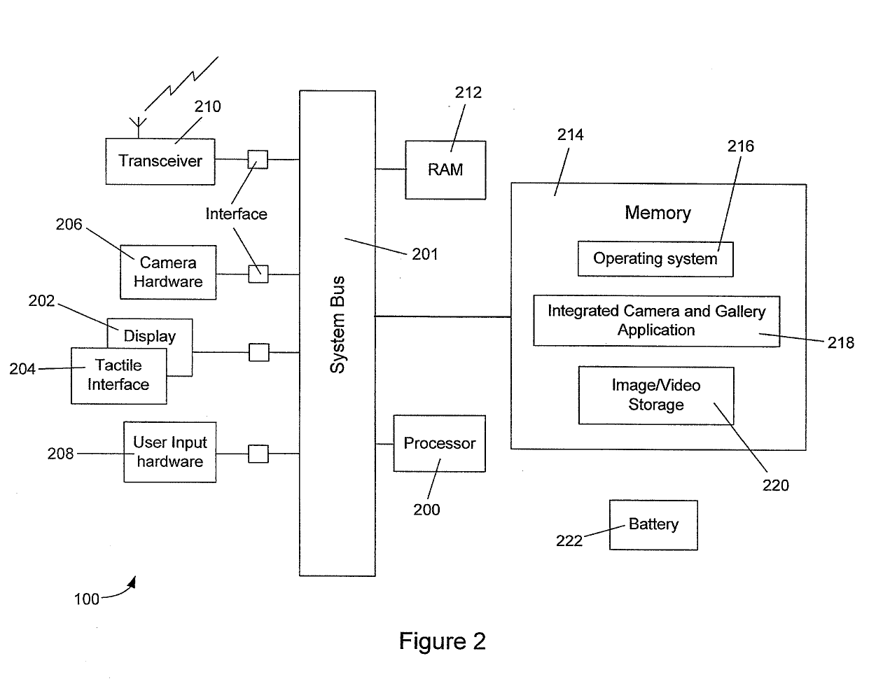

FIG. 2 is a block diagram illustrating some aspects of the hardware and software configuration of the terminal 100. The terminal includes a processor 200. The processor 200 communicates with the other hardware components via a system bus 201. Each hardware component is connected to the system bus 201 either directly or via an interface. The touch sensitive display 102 comprises a display part 202 and a tactile interface part 204 and is connected to the system bus 201 via an interface. Also connected to the system bus 201 by interfaces are camera hardware 206, user input hardware 208 and a transceiver 210. Connected directly to the system bus are the processor 200, working or volatile memory, such as Random Access Memory (RAM), 212 and a non-volatile memory 214. The non-volatile memory 214 stores an operating system 216, an integrated camera and gallery application 218 and an image and video storage area 220. The terminal 100 also houses a battery 222 to power the terminal 100.

The processor 200 is configured to send and receive signals, via the system bus 201, to and from the other components in order to control operation of the other components. For example, the processor 200 controls the display of content on display 202 and receives signals as a result of user inputs from tactile interface 204. The touch sensitive display 102 may be a resistive touch screen or capacitive touch screen of any kind.

Camera hardware 206 may comprise any image sensing technology such as a charge-coupled device (CCD) or an active pixel sensor such as a complementary metal oxide semiconductor (CMOS) device.

The user input hardware 208 may refer to the hardware keys 104 and/or image capture key 106. The user input hardware 208 may also include a QWERTY or numeric keypad, a trackpad, a movement or proximity detector, a remote control or a microphone. The user input hardware 208 functions in addition to the touch sensitive display 102, which also receives user inputs.

The terminal 100 may have a transceiver for communicating over a wireless link, such as a GSM, CDMA, UMTS, LTE, WiMax or IEEE 802.11 (Wi-Fi) link. In embodiments in which the terminal 100 is a digital camera or similar, the transceiver may not be present.

The processor 200 may be an integrated circuit of any kind. The processor 200 may access RAM 212 in order to process data and may control the storage of data in memory 214. Memory 214 may be a non-volatile memory of any kind such as a Read Only Memory (ROM), a flash memory and a magnetic drive memory. The RAM 212 may be a RAM of any type, for example Static RAM (SRAM), Dynamic RAM (DRAM) or a Flash memory.

The processor 200 operates under control of the operating system 216. The operating system 216 may comprise code relating to hardware such as the display 102, user inputs 208 and transceiver 210, as well as the basic operation of the terminal 100. The operating system 216 may also cause activation of other software modules stored in the memory 214, such as the integrated camera and gallery application 218. The operating system 216 may for instance be a Symbian operating system or a MeeGo operating system.

The integrated camera and gallery application 218 comprises software which controls operation of camera hardware 206 as well as software that causes the processor 200 to control what is output on the display 202. For example, the processor 200 may be controlled to display on display 202 the direct output from camera hardware 206, such that the display 202 acts as a viewfinder.

The integrated camera and gallery application 218 is also configured to access the image/video storage 220, which is an area of memory in which saved images and videos are stored. The integrated camera and gallery application 218 is configured to control the display of multiple outputs on display 202, such as the direct output from camera hardware 206 and one or more stored images from image/video storage 220. The integrated camera and gallery application 218 may determine and alter the size, position, displaying order, opacity, brightness and other display parameters of the stored images and videos. The integrated camera and gallery application 218 may also allow a user to alter parameters of stored images and videos.

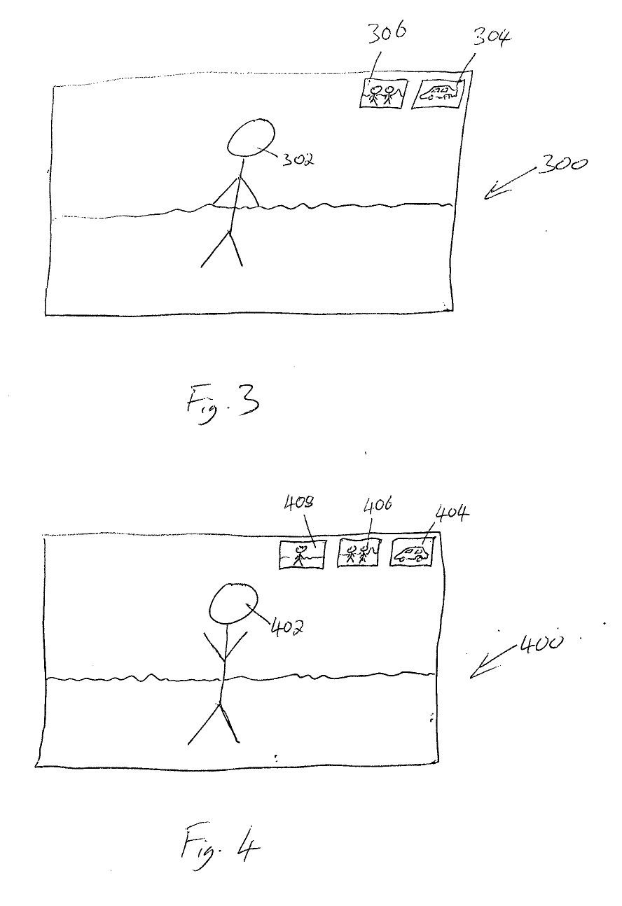

FIGS. 3 to 6 show various screen configurations which the integrated camera and gallery application 218 may control the display 202 to assume. Referring now to FIG. 3, a first screenshot 300 is shown.

The screenshot 300 is displayed on the display 202 of the terminal 100. In order to cause the display 202 to act as a viewfinder for the camera, a user of the terminal 100 may navigate a menu of the terminal 100 and activate the integrated camera and gallery application 218 by selecting an icon from the menu. Alternatively, or in addition, the user may press a hardware key 104 or the image capture key 106 to activate the integrated camera and gallery application 218. Once activated, the integrated camera and gallery application 218 is configured to begin outputting the live image data captured by camera hardware 206 to the display 202. The live image output can be termed a viewfinder output. The live image output includes a short delay that necessarily results from current viewfinder technology. The integrated camera and gallery application 218 is also configured to display, as an overlay of the live image data, thumbnails of images stored in the image/video storage 220. Specifically, the integrated camera and gallery application 218 may control the processor 200 to retrieve image data from the image/video storage 220 and to display reduced size (small) versions of the images at the top edge of display 202.

When an image is saved to the image/video storage 220, a time and date of the saving are also associated with the image as metadata. Alternatively, if an image is loaded onto the terminal, the image file may already have associated with it metadata indicating a time and date of recordal of that image. Images stored in the image/video storage 220 may be arranged in a sequence which is ordered chronologically.

The screenshot 300 shows a live image 302 which is the direct output from camera hardware 206. The screenshot 300 also has a first thumbnail image 304 and a second thumbnail image 306 displayed in the top right corner of the screen, along the top edge of the screen.

The second thumbnail image 306 is the most recently saved image (i.e. the last image in the sequence), as determined by the time and date metadata associated with each image. The first thumbnail image 304 is the second most recently saved image. In general the thumbnail images may be displayed in reverse chronological order. In the screenshot 300, the thumbnail images 304, 306 are displayed in reverse chronological order from left to right in a row at the top edge of the screen. However, the thumbnail images may be displayed along one or more of the left side, right side, top or bottom of the screen. The thumbnail images may be sized so that, for instance, between three and seven images can be seen along any one side of the screen.

The thumbnail images may be opaque images which obscure the part of the live image 302 over which they are located. Alternatively, the thumbnail images may be semi-transparent or translucent such that the part of the live image 302 which each thumbnail overlies can still be discerned. A user of the terminal 100 may capture the live image 302 being displayed by depressing the image capture key 106 or by touching a image capture software key (not shown) on the display 202 itself. In some embodiments, a user touch input at any point on the display 202 which is not covered by a thumbnail image may cause the camera hardware 206, under control of the integrated camera and gallery application 218, automatically to perform focussing and other preparatory steps, and then to capture the live image 302. The image data of the live image 302 is then saved in image/video storage 220.

FIG. 4 depicts a screenshot 400 which results after a capturing of the live image 302. The display 202 continues to display a live image 402, which is the direct output from camera hardware 206 although with the short delay that necessarily results from current viewfinder technology. The screenshot 400 has a first thumbnail image 404, a second thumbnail image 406 and a third thumbnail image 408 displayed along the top edge of the screen.

The captured version of the previously live image 302 now appears as the third thumbnail image 408 because it is the most recently saved image. Depending on how many thumbnail images the integrated camera and gallery application 218 is configured to display, some older thumbnail images may no longer be displayed in order to make room for the newly saved thumbnail image. The capturing of the live image 302 may be accompanied by a sound and/or an animation. For example, when an image capture key is pressed, the live image 302 may freeze momentarily such that the captured image fills the whole display screen. The captured image may then gradually reduce in size while moving towards the thumbnail images such that it comes to rest as a thumbnail sized image at the left end of the row of displayed thumbnails.

Having the captured image displayed immediately as a thumbnail within the viewfinder allows a user of the terminal 100 to assess the quality of the photograph they have taken without having to navigate away from a camera application. If the captured image is not as the user desires, it is convenient for the user to quickly take another. If a user were to take several photographs of the same subject matter, the display of thumbnails of the most recently saved images allows an immediate comparison between the photographs while the subject matter is still visible on the display 202.

In some embodiments the integrated camera and gallery application 218 may be configured to operate in a “multi shot” mode. In this mode, a continuous user input such as continuous depression of the image capture key 106 causes several images to be captured in succession. The delay between each successive image capture may be configurable. A default delay may be 1 second. As each image is captured in a multi shot mode, a thumbnail of that image may appear with the other thumbnail images as previously described with reference to FIG. 4.

The animation, previously described, which may accompany the capturing of the live image may be omitted when capturing images in multi shot mode. This allows a user to be able to use the display 202 as a viewfinder while the multi shot capturing is occurring.

The integrated camera and gallery application 218 may also be configured to control the camera hardware 206 to capture a video of the live image 302. During the capturing of video, the display 202 continues to show the live image 302. The integrated camera and gallery application 218 may also be configured to allow still images to be captured while a video recording is ongoing. This may be accomplished via the user input hardware 208 or via a software key on the display 202. In some embodiments, the integrated camera and gallery application 218 may be further configured to generate snapshots periodically (for example, every 10 seconds). In some embodiments, a software key may be displayed on display 202 while a video recording is ongoing. When activated by a user, this software key causes an image of the currently displayed video frame to be captured. When still images are captured while a video recording is ongoing, thumbnails of the captured images may appear along an edge of the display 202 in the same manner as described with reference to FIGS. 3 and 4. When snapshots are being generated, the snapshots may appear along an edge of the display 202 in the same manner as described with reference to FIGS. 3 and 4.

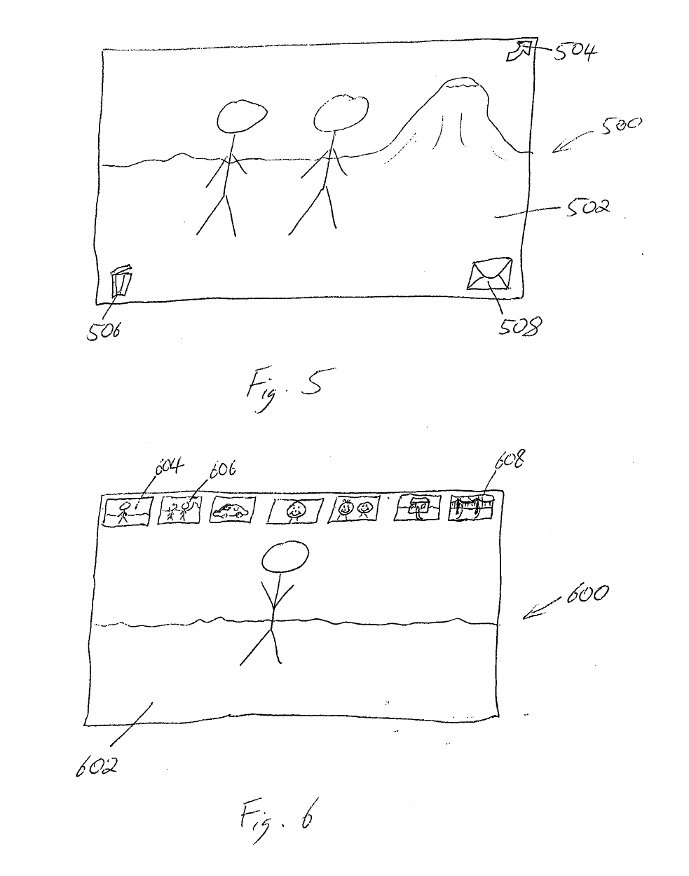

The thumbnail images of FIGS. 3 and 4 are active objects with which the user of the terminal 100 may interact. A feature of the integrated camera and gallery application 218 is that the thumbnail images may be enlarged while the viewfinder remains active. FIG. 5 shows a screenshot 500 which results after the second thumbnail image 406 has been selected by a user of the terminal 100.

The screenshot 500 displays an image 502 which is a full size version of the second thumbnail image 406, and which fills substantially the whole of the display 202.

The screenshot 500 also shows a diminish indicator 504, a delete software key 506 and a sharing option software key 508. The second thumbnail image 406 may be selected by a user with a single touch input within the area of the second thumbnail image 406. The enlarging of the second thumbnail image 406 may be accompanied by an animation, for example the image may gradually increase in size until it fills the whole of the display 202.

When in the arrangement of FIG. 5, the touch sensitive display 102 may be responsive to further touch inputs. For example a leftwards swipe may display the next image in the sequence of images stored in image/video storage 220. A rightwards swipe may display the previous image in the sequence. The touch sensitive display 102 may additionally be responsive to a touch input at the right or left edge of the screen to achieve the same effect as the leftwards or rightwards swipe input respectively.

While in the configuration of FIG. 5, the image 502 covers the entire live image being output from the camera hardware 206 such that the display 202 is no longer acting as a viewfinder. The integrated camera and gallery application 218 may be configured to disable the camera hardware 206 so that live image data is no longer generated, which reduces the power consumption of the terminal 100.

Alternatively, the camera hardware 206 may remain active so that the display 202 may quickly be able to switch between, for example, the configurations of FIGS. 4 and 5. In some other embodiments, the image 502 may not fill the whole of the display 202, but may fill almost all of the display 202. In these embodiments, the second thumbnail image 406 may be displayed centrally on the display 202 and edges of the viewfinder image may be visible. These edges may be responsive to a user touch input to immediately return the display 202 to the configuration of FIG. 3 or FIG. 4. Small portions of the first thumbnail image 404 and third thumbnail image 408 may be visible on the left and right respectively of the second thumbnail image 406. This arrangement may provide a visual indication to a user of the terminal 100 that the terminal 100 is in a gallery mode and they may view other stored images.

In some embodiments, the terminal 100 is not responsive to a user input to capture further images while in this configuration. In some other embodiments, the terminal 100 is responsive to a user input to capture further images while in this configuration. Capturing a new image while in the configuration of FIG. 5 may cause the newly captured image to fill the whole of the display 202, replacing the currently displayed image 502.

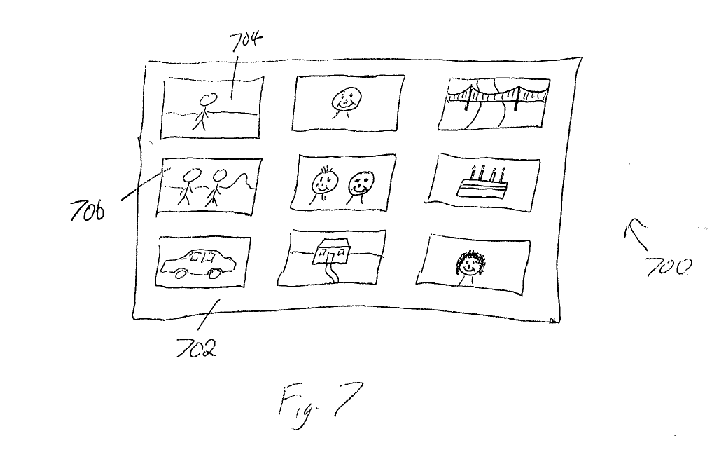

The diminish indicator 504 may take the form of an arrow, or any other suitable icon, located in the top right corner of the display 202. The diminish indicator 504 indicates to a viewer of the display 202 that they may return the display 202 to the configuration shown in FIG. 4. The terminal 100 may be responsive to a touch input on or near the diminish indicator 504 to achieve this function. In addition, the terminal 100 may be responsive to a swipe input beginning in the main body of the display 202 and moving towards the top right corner of the display 202 to provide this function. Either of these inputs may cause the display 202 to revert to the configuration shown in FIG. 4. Alternatively a touch input anywhere on the image 502 may cause the display to return to the configuration of FIG. 4. Alternatively, or in addition, the display 202 may be returned to the configuration of FIG. 4 in response to the activation of one or more hardware keys 106. In some embodiments, selection of the diminish indicator 504 (or activation of the functions represented by the diminish indicator 504) may cause the display 202 to return to the last displayed configuration. This may be the display configuration shown in FIG. 6 or 7, as described below. In addition, where the terminal 100 is not responsive to a user input to capture further images while in the configuration of FIG. 5, the display 202 may be returned to its previous configuration in response to activation of the image capture key 106.

The delete software key 506 may take the form of an image of a dustbin or any other suitable graphic, and in this example is located in the bottom left corner of the display 202. The terminal 100 may be responsive to a touch input on or near the delete software key 506 to delete the image 502 which is currently displayed. Selection of the delete software key 506 by a user may alternatively cause a ‘delete options’ pop-up window or overlay to appear. The delete options pop-up window may give a user of the terminal 100 a number of options such as to delete the image, cancel the deletion of the image or to move the image to an alternative location within the memory 214. Alternatively, or in addition, the delete options pop-up window may be displayed in response to the activation of one or more hardware keys 106 or a long press on the delete software key 506.

While in the configuration shown in FIG. 5, the display 202 may have at least one sharing option software key 508. FIG. 5 shows a sharing option software key 508 which takes the form of an envelope. The envelope may represent an SMS message and/or an email message sharing option. The terminal 100 key 508 may be responsive to a touch input on or near the sharing option software key 508 to provide access to this function. When the sharing option software key 508 is selected, the displayed image 502 may be attached to an SMS or email message. The terminal 100 may navigate away from the viewfinder/gallery to a messaging application so that a user can add text and select recipients for the message. Once the message has been sent, or the user has cancelled the sending of the message, the display 202 may return to that of the viewfinder/gallery.

The display 202 may have further sharing option software keys 508 representing, for example, a social networking service or a photograph sharing service. Selection of these keys may cause the image 502 to be uploaded to the associated service. The terminal 100 may navigate away from the viewfinder/gallery to a browser application directed to a website of the service or to another application associated with the service so that a user can add text to be uploaded with the image 502. Once the image has been uploaded, or the user has cancelled the uploading of the image, the display 202 may return to that of the viewfinder/gallery.

Each sharing option may have its own icon to act as the sharing option software key 508. These icons may be arranged in a row along the bottom of the display 202 or any other edge of the display 202 except the edge that is reserved for showing the thumbnails. In some embodiments, only one sharing option software key 508 is displayed, irrespective of the number of sharing options available. Selection of this sharing option software key 508 may cause a sharing options pop-up window or overlay to appear. The sharing options pop-up window may list all of the sharing options available to the user of the terminal 100 for sharing the image 502. The list may have an entry entitled “add service”. A user may select this entry to configure a sharing option which is not currently shown as being available.

In addition, image editing options may be available. These editing options may be viewed and applied via a separate software key (not shown).

As has been previously described, while the display 202 is in the configuration of FIG. 4, the terminal 100 may be responsive to a user input to enlarge one of the thumbnail images. The terminal 100 may also be responsive to user inputs to show more or fewer thumbnail images.

Referring now to FIG. 6, a screenshot 600 depicting a further configuration of the display 200 is shown. The screenshot 600 shows a live image 602, which is the direct output from camera hardware 206. Arranged along a top edge of the display 202 are seven thumbnail images, including a first thumbnail image 604, a second thumbnail image 606 and a seventh thumbnail image 608.

The first thumbnail image 604 is the most recently saved image (i.e. the last image in the sequence), as determined by the time and date metadata associated with each image. The second thumbnail image 606 is the second most recently saved image. The thumbnail images are displayed in reverse chronological order from left to right in a row at the top edge of the screen. The seventh thumbnail image 606 is the seventh most recently saved image and the last image which is displayed. There may however be older images stored in image/video storage 220 which are not displayed as thumbnails.

The screenshot 600 may result when a user provides a touch input at any of the thumbnail images shown in FIG. 4 and performs a translation input motion to the left. Such a motion results in dragging of the thumbnails. As the user drags the thumbnails to the left, more thumbnail images enter the display area from the right edge of the display 202. In some embodiments, once the first thumbnail image 604 reaches the left edge of the display 202, as shown in FIG. 6, the thumbnail images cannot be dragged further to the left. In some other embodiments a user can continue to drag the thumbnail images to the left after the first thumbnail image 604 has reached the far left edge. In these embodiments, the first thumbnail image may exit the display area at the left edge of the display 202 allowing a new thumbnail image to enter from the right edge of the display 202. A user may also provide a touch input at any of the displayed thumbnail images and drag the thumbnail images to the right. A user may continue to drag the thumbnail images to the right until only the first thumbnail image 604 is visible and is located in the top right corner of the display 202 or until the user's finger reaches the edge of the display 202. If a user provides a swipe input, which is defined as an input in which translation motion exists as the input is ended, e.g. by removal of the user's digit from the display 202, the thumbnail images may continue to move after the swipe input has ended. In this case, the speed of movement may relax until movement stops. If a user provides a fast swipe input across substantially the whole width of the area of the display 202 in which the thumbnail images are displayed, the terminal 100 may cause the first or last thumbnail images in the sequence to be immediately displayed. For example, in response to a rightwards fast swipe input across substantially the whole width of the display 202, the first (most recent) thumbnail image may be immediately displayed. In response to a leftwards fast swipe input across substantially the whole width of the display 202, the last (oldest) thumbnail image may be immediately displayed.

In the screenshot 600, seven thumbnail images are visible; however this number may vary depending on the width of the display 202, the size of the thumbnail images and user preference settings. A user may drag the thumbnail images to the left to show a maximum number of the most recently saved images. If a user has captured several images of the same subject matter, this feature allows them to quickly compare thumbnails of those images. The viewfinder remains active during user interaction with the thumbnail images. This provides a further advantage of allowing a user to compare a saved thumbnail image with the live image 602. For example, the first thumbnail image 604 may be of the same subject matter as the live image 602. A user may compare the first thumbnail image 604 with the live image 602 in order to decide whether to capture a further image. At other times, a user may want to see as much of the live viewfinder image as possible. The user may maximise the visible viewfinder area by dragging the thumbnail images to the right until only the first thumbnail image 604 is visible. The dragging of the thumbnail images, comparison between thumbnail images and the live image 602 and capturing of further images may all be accomplished without any navigation, by the user, of menus or different applications.

When in the configuration of FIG. 6, the display 202 may be further responsive to a single touch input to cause the selected thumbnail image to be enlarged. For example, if a user selects the second thumbnail image 606 the display 202 reverts to that shown in FIG. 5. A user may diminish the enlarged image by activating a diminish indicator 504 as previously described with reference to FIG. 5, or by performing a “pinch” touch input in which the separation between two distinct touch inputs decreases.

Referring now to FIG. 7, a screenshot 700 depicting a further configuration of the display 200 is shown. The screenshot 700 shows a number of thumbnail images displayed in a grid formation. The screenshot 700 has a background 702 and at least a first thumbnail image 704 and a second thumbnail image 706.

The screenshot 700 may result when a user provides a touch input at any of the thumbnail images shown in FIG. 3, 4 or 6 and drags downwards or towards the centre of the display 202. The repositioning of the thumbnail images may be accompanied by an animation. For example the thumbnail images may move smoothly from the top edge of the display 202 to their new positions. Those thumbnail images which are visible in screenshot 700 but which were not previously visible may enter from the right edge of the display 202 and move smoothly to their new positions. The images in the grid of FIG. 7 may be larger than the thumbnail images shown in FIGS. 3, 4 and 6. The display 202 may be returned to its previous configuration when a user provides an upwards swipe touch input. The animation previously described may be performed in reverse to accomplish this change.

The screenshot 700 represents a gallery mode of the integrated camera and gallery application 218. However, since the functions of the camera and of the image gallery are integrated into a single application, the camera hardware 206 may remain active while the display 202 is in this configuration. In some embodiments, the background 702 shows a “paused” viewfinder image. This paused image may be the last live image data displayed on the display 202 before the thumbnail images were repositioned. The paused image may be a greyscale transformation of the last live image data displayed on the display 202. In some other embodiments, the background 702 continues to show the live image which is the direct out put of the camera hardware 206. Alternatively, the background 702 may be black or some other plain colour.

When in the configuration of FIG. 7, the display 202 may be further responsive to a single touch input to cause the selected thumbnail image to be enlarged. For example, if a user selects the second thumbnail image 706 the display 202 reverts to that shown in FIG. 5. A user may diminish the enlarged image by activating a diminish indicator 504 as previously described with reference to FIG. 5, or by performing a “pinch” touch input. The grid of thumbnail images may not occupy the whole of the display 202. Therefore, some of the live viewfinder image or paused viewfinder image may be visible around the edge of the grid. The terminal may be responsive to a user touch input at the image visible around the edge of the grid to immediately return the display 202 to the previous configuration, for example the configuration of FIG. 3, 4 or 6.

The first thumbnail image 704 is the most recently saved image (i.e. the last image in the sequence), as determined by the time and date metadata associated with each image. The thumbnail images are displayed in reverse chronological order from top to bottom in columns. The grid shown in FIG. 7 has three rows of three columns; however this is just an example. While in the configuration of FIG. 7, the terminal 100 may be responsive to further user inputs to cause further thumbnail images to be displayed. The terminal 100 may, for example, be responsive to a leftwards swipe touch input to show older images and to a rightwards swipe touch input to show more recent images.

While in the video mode, a user may browse thumbnails of the captured images as previously described with reference to FIGS. 6 and 7. During this browsing, the camera hardware 206 may remain active and the video recording may continue. A user may also enlarge thumbnail images as previously described with reference to FIGS. 4 and 5 while a video recording is ongoing. This feature also operates when the camera is configured to capture still images periodically, as described above. These features are particularly useful when the terminal 100 is being used to record a video or still while on a tripod or other stand. In these circumstances a user can browse saved images without shaking the terminal and affecting the quality of the video recording or stills capture.

The user inputs described above with reference to FIGS. 3 to 7 are touch inputs received at a touch sensitive display 102. However, the user inputs could be implemented in any other suitable way, such as with hardware keys only, with voice commands or with gestures and/or shakes of the terminal 100, for instance as may be detected by an accelerometer, proximity sensor or optical sensor arrangement within the terminal 100.

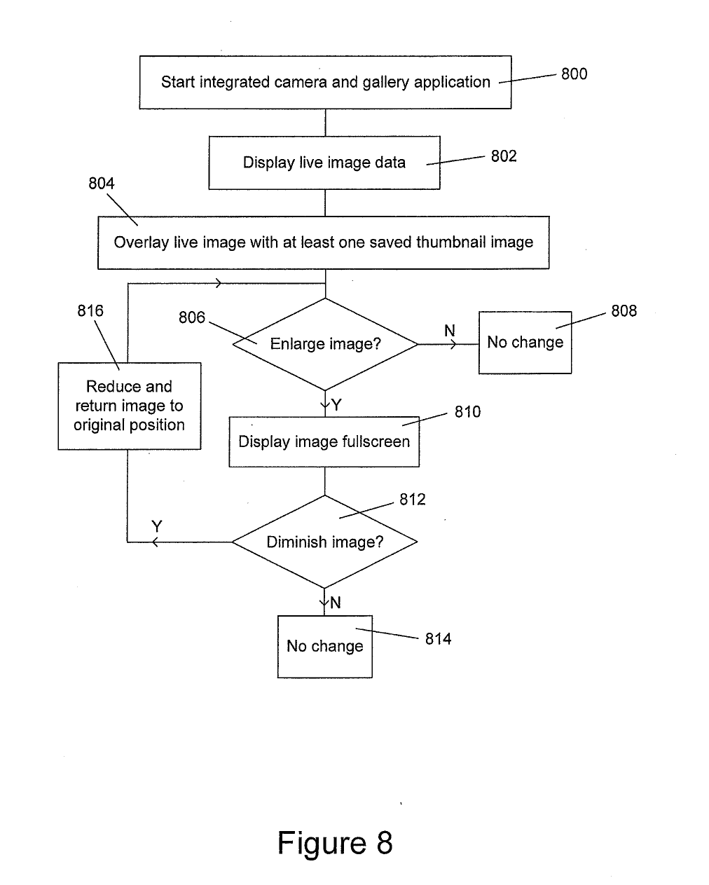

Referring now to FIG. 8, a flow chart is shown illustrating exemplary operation of the terminal 100. At step 800 the integrated camera and gallery application 218 is started on the terminal 100. This may be achieved by a user causing the application 218 to execute by selecting its icon from a menu or a home screen or by depressing the image capture key 106, for instance. At step 802 live image data is displayed. The integrated camera and gallery application 218 controls processor 200 to activate camera hardware 206 and to cause the image data generated to be displayed immediately on display 202.

At step 804 the live image being displayed on display 202 is overlaid with at least one saved image thumbnail. The integrated camera and gallery application 218 causes this step to occur by controlling the processor to retrieve saved image data from the image/video storage 220 in memory 214 and to display “thumbnail sized” versions of at least one of the saved images. The displayed thumbnail images may obscure the part of the live image which they overlay. During this step, the display 202 continues to show a live image and the terminal is responsive to user commands to capture an image. Step 804 is represented by the screen configurations shown in FIGS. 3 and 4.

At step 806 it is determined if a user input to enlarge one of the displayed thumbnail images is received. As previously described this user input may take the form of a touch input or hardware key activation. If no user input is received, at step 808, no change in the displayed content occurs. If a user input is received, at step 810 the thumbnail image which is the subject of the input is displayed in a full screen mode. In this mode the saved image occupies all or substantially all of the display area. The image therefore obscures the live image which may be disabled while the display 202 is in this configuration. The result of step 810 is represented by the screen configuration shown in FIG. 5.

At step 812 it is determined if a user input to diminish the image is received. This step occurs while the image is being displayed in a full screen mode in step 810. If no input is received then, at step 814, the image continues to be displayed in a full screen mode and there is no change in the displayed content. If it is determined that a user input to diminish the image is received then, at step 816, the image is reduced in size and returned to its previous position on the display screen. The process then returns to step 806. Step 816 may be represented by a change in display configuration from that of FIG. 5 to that of FIG. 4. Each of the “no change” results at steps 808 and 814 may represent a temporary end to the process.

Embodiments have been described in relation to the display and capture of images; however the concepts are equally applicable to the display and capture of videos. The integrated camera and gallery application 218 may be configured to control the capture of both images and videos and to cause a software key for toggling between the two modes to be displayed on any or all of the screenshots 300, 400, 500, 600, 700. Video capture may be initiated in the same manner as image capture, e.g. by pressing a software or hardware key. Videos are stored in the image/video storage 220 and may also be stored in a chronological sequence. A video file may be represented as a thumbnail image comprising the first frame of the video. When displaying thumbnail images in the configurations of FIGS. 3, 4, 6 and 7, the integrated camera and gallery application 218 may control only image thumbnails to be displayed when the terminal 100 is in image capture mode and only video thumbnails to be displayed when the terminal 100 is in video capture mode. Alternatively, both image and video thumbnails may be displayed irrespective of the capture mode.

In general, having both a camera viewfinder displaying a real-time image and a gallery of saved images integrated into a single application is more convenient for a user of the terminal 100. Therefore the functionality and convenience of the terminal 100 are increased. Embodiments allow a user quickly, and with a minimum of input, to enlarge and reduce in size thumbnail versions of saved images while viewing and capturing real-time images. No switching between a gallery application and a camera application, or a playback mode and a capture mode, is required.

It will be appreciated that the above described embodiments are purely illustrative and are not limiting on the scope of the claims. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. (canceled)

2. Apparatus as claimed in claim 23, wherein the computer-readable code when executed controls the at least one processor:
to be responsive to an image capture command to capture a first image; and
to cause to be displayed, over a portion of the displayed real-time image, a first thumbnail image representing the first captured image.

3. Apparatus as claimed in claim 2, wherein the computer-readable code when executed controls the at least one processor to cause the first thumbnail image representing the first captured image to be displayed immediately on capture.

4. Apparatus as claimed in claim 2, wherein the computer-readable code when executed controls the at least one processor:
to be responsive to a second image capture command to capture a second image; and
to cause to be displayed, over a portion of the displayed real-time image and adjacent the first thumbnail image, a second thumbnail image representing the second captured image.

5. Apparatus as claimed in claim 4, wherein the computer-readable code when executed controls the at least one processor to cause the second thumbnail image representing the second captured image to be displayed immediately on capture.

6. Apparatus as claimed claim 23, wherein the computer-readable code when executed controls the at least one processor to cause the or each thumbnail image to be displayed at or near an edge of a display area.

7. Apparatus as claimed in claim 6, wherein the computer-readable code when executed controls the at least one processor to be responsive to a first user input to cause a greater number of thumbnail images to be displayed at or near the edge of the display area.

8. Apparatus as claimed in claim 7, wherein the computer-readable code when executed controls the at least one processor to be responsive to a second user input to cause fewer thumbnail images to be displayed at or near the edge of the display area.

9. Apparatus as claimed claim 23, wherein the computer-readable code when executed controls the at least one processor to be responsive to a third user input to cause one of the at least one thumbnail images to be enlarged to fill substantially the whole of the display.

10. Apparatus as claimed in claim 9, wherein the computer-readable code when executed controls the at least one processor to be responsive to a fourth user input to cause the enlarged image to return to being a thumbnail image.

11. Apparatus as claimed in claim 9, wherein each user input is a touch input received at a touch sensitive screen.

12. Apparatus as claimed in claim 23, wherein the computer-readable code comprises a software application stored in a memory.

13. A method comprising:
causing to be displayed a real-time image that represents image data output from an image sensing device; and
causing to be displayed, over a portion of the displayed real-time image, at least one thumbnail image.

14. A method as claimed in claim 13, comprising:
responding to an image capture command by capturing a first image; and
causing to be displayed, over a portion of the displayed real-time image, a first thumbnail image representing the first captured image.

15. A method as claimed in claim 14, comprising causing the first thumbnail image representing the first captured image to be displayed immediately on capture.

16. A method as claimed in claim 14, comprising:
responding to a second image capture command by capturing a second image; and
causing to be displayed, over a portion of the displayed real-time image and adjacent the first thumbnail image, a second thumbnail image representing the second captured image.

17. A method as claimed in claim 16, comprising causing the second thumbnail image representing the second captured image to be displayed immediately on capture.

18. A method as claimed in claim 13, comprising causing the or each thumbnail image to be displayed at or near an edge of a display area.

19. A method as claimed in claim 13, comprising responding to a third user input by causing one of the at least one thumbnail images to be enlarged to fill substantially the whole of the display.

20. (canceled)

21. (canceled)

22. A non-transitory computer-readable storage medium having stored thereon computer-readable code, which, when executed by computing apparatus, causes the computing apparatus to perform a method comprising:
causing to be displayed a real-time image that represents image data output from an image sensing device; and
causing to be displayed, over a portion of the displayed real-time image, at least one thumbnail image.

23. Apparatus, the apparatus having at least one processor and at least one memory having computer-readable code stored thereon which when executed controls the at least one processor:
to cause to be displayed a real-time image that represents image data output from an image sensing device; and
to cause to be displayed, over a portion of the displayed real-time image, at least one thumbnail image.
